(19) United States
(12) Patent Application Publication
(10) Pub. No.: US 2016/0078418 A1
(43) Pub. Date: Mar. 17, 2016

(54) Methods and Arrangements for Building a Value-Add Service Network

(71) Applicant: Basware Oyj, Espoo (FI)

(72) Inventor: Timo HOTTI, Espoo (FI)

(21) Appl. No.: 14/847,113

(22) Filed: Sep. 8, 2015

(30) Foreign Application Priority Data
Sep. 12, 2014 (FI) 20140245

(51) Int. Cl. G06Q 20/14; G06Q 20/40; H04L 12/24

(52) U.S. Cl. CPC G06Q 20/14; H04L 41/5096; H04L 41/5051; H04L 41/5029; G06Q 20/405

(57) ABSTRACT

The invention concerns, inter alia, a computer executable method for executing a business process comprising a plurality of participants and involving a plurality of data interfaces in a transaction transmission network. The method is characterized in that the method comprises steps for receiving a transaction or state change event from an interface acting as a source of transactions or state change events, analysing the content of the transaction or state change event to identify at least one process that is applicable to the transaction or state change event, validating the transaction or state change event using the validation rules of the identified process, routing the transaction or state change event to at least one recipient interface according to the specification of the identified process, receiving from at least one participant of the process an invoicing event indicating a fee charged from a first participant of the process, and generating, according to the specification of the identified process, a second invoicing event indicating a fee to be credited to a second participant of the process. An arrangement is also disclosed.

### BACKGROUND

A business commerce network, e.g. a transaction transmission network adapted to transmit business transactions such as purchase orders and invoices of a business process is subject to continuous evolution. New requirements emerge gradually for both the data content of the transactions to be transmitted in the network as well as the state changes related to the transactions when new processes need to be supported. The exact functional requirements of the processes may be specific to each set of participants of the process, e.g. the sender, the receiver and intermediaries, e.g. routers of the transactions of the process. Typically, the recipient of a transaction specifies, which data content and state change events it requires for the electronic handling of the transaction of the process the recipient wants to support. The senders and intermediaries of the transactions may each have different capabilities. In order to be able to comply with the requirements of the processes specified by the receivers of the transactions, the senders and intermediaries of the transactions may need to adapt their capabilities in an efficient manner.

The process between the sender and receiver of the transaction may also produce a value-add event related to the transaction. For example, the receiver of the transaction may provide a financing service to the invoice received from the sender of the transaction. The execution of the financing service for a transaction may for example create a billing event comprising a fee payable by the sender of the transaction. A precondition to the billing event is that the interfaces of the participants of the process, e.g. transaction source, transaction routing operator and the financing service provider allow the implementation of the process, e.g. financing. No value-add event can occur unless the preconditions for the process producing such events have been met.

The participants, e.g. the vendors of transaction sources, routing operators and application service providers, of the business commerce network typically prioritize their investments on the interfaces available in the network based on the revenues they can anticipate on their investments from their sources of revenue.

An object of the invention may be to provide a method and/or an arrangement for specifying business processes between a plurality of sources and destinations in a transaction transmission network. Another object of the invention may be to provide a method and/or an arrangement for identifying and facilitating the optimal development path for the various services and their interfaces in the network. Yet another object of the invention may be to provide a method and and arrangement for executing a process involving a plurality of data sources and destinations in the network and manage the revenues associable with the process.

### BRIEF DESCRIPTION OF THE INVENTION

An aspect of the invention is a computer executable method for specifying a business process between a plurality of participants in a transaction transmission network. The method may be characterized in that the method comprises steps for specifying a plurality of participant types for the process, wherein the participant types are selected from a set comprising at least transaction senders, transaction recipients, state change event senders and service providers, specifying data content requirements for the transactions of the process, optionally specifying state change event requirements for the process, specifying validity rules for the process, and specifying at least one revenue management rule for the process.

Another aspect of the present invention may be a method for managing development of at least one data source in a transaction transmission network to become compliant for a process involving a plurality of interfaces, e.g. at least one data source and at least one data destination. The method may be characterized in that it comprises e.g. steps for selecting a business process definition comprising a plurality of participant types, identifying a data source associable with a participant type defined in the process definition, comparing the capabilities description of the identified data source with the data content requirements of the process, identifying a deficiency in the capabilities of the identified data source, creating a deficiency description object about the identified deficiency, estimating, using the revenue management rules of the process, the estimated value of the data source after having the deficiency remedied, and publishing the deficiency description object to at least one recipient.

Yet another aspect of the present invention may be a method for executing, by at least one computer, a business process comprising a plurality of participants and involving a plurality of data interfaces in a transaction transmission network. The method may be characterized e.g. in that it comprises computer executable steps for receiving a transaction or state change event from an interface acting as a source of transactions or state change events, analysing the content of the transaction or state change event to identify at least one process that is applicable to the transaction or state change event, validating the transaction or state change event using the validation rules of the identified process, routing the transaction or state change event to at least one recipient interface according to the specification of the identified process, receiving from at least one participant of the process an invoicing event indicating a fee charged from a first participant of the process, and generating, according to the specification of the identified process, a second invoicing event indicating a fee to be credited to a second participant of the process associable e.g. with the source of the transaction or state change event.

The method may also comprise the step of amending the identified process according to the results of the validation of the transaction. The step of amending the identified process may comprise invocation of a service adapted to correct the deficiency in the data of the transaction identified in the validation of the transaction. The method may also comprise the step of estimating the financial effect of executing the amended step.

In an embodiment, the step of amending the identified process comprises creating a deficiency description object adapted to comprise information requesting upgrading the interface into one capable of automatically producing valid transactions or state change events for the process. The deficiency description object may comprise financial information e.g. about anticipated revenues to a participant of the process, should the deficiency be corrected. In an embodiment, the deficiency description objects may be prioritized according to the financial information.

Still yet another aspect of the present invention may be a computer executable method for managing and/or distributing (sharing) revenue in a transaction transmission network. The method may be characterized e.g in that it comprises steps for routing a transaction or a state change event from a source to at least one destination, recording a value-add event occurring in one of the source and at least one destination, charging a fee from the value-add event according to a revenue management rule and crediting at least part of the charged fee, according to a revenue management rule, e.g. to the source or at least one of the destinations of the transaction or state change event.

In a preferred embodiment, the value-add event comprises or is associable with a billing record associable with a service fee.

The credited source of the transaction or state change event may be identified using routing information associable with the transaction or state change event transmitted in the transaction transmission network.

Any of the steps mentioned herein may be executable in the memory of a computer the processor processor of the computer.

Another aspect of the present invention may be an arrangement comprising at least one server computer. The arrangement may be adapted to comprise computer executable means for performing at least some of the steps of at least one of the methods disclosed herein.

Yet another aspect of the present invention may be a tangible computer readable memory medium comprising a computer program product. The product may be adapted to comprise computer executable instructions for the purpose of performing at least some of the steps of at least one of the methods disclosed herein.

### DRAWINGS

Some preferred embodiments of the invention are described below with references to accompanied figures, where:

FIG. 1 depicts an arrangement of servers according to an embodiment of the present invention,

FIG. 2 illustrates some functional components of a preferred embodiment of the present invention,

FIG. 3a shows in the form of a flow chart the steps of a method for checking availability of a business process between some interfaces according to a preferred embodiment of the present invention,

FIG. 3b shows in the form of a flow chart the steps of a method for specifying a process development task in a transaction network according to a preferred embodiment of the present invention,

FIG. 3c shows in the form of a flow chart the steps of a method for specifying a process according to a preferred embodiment of the present invention,

FIG. 4a shows an example of the interfaces of an exemplary embodiment of the present invention,

FIG. 4b shows another example of a method of executing a financing process according to an exemplary embodiment of the present invention,

FIG. 5a shows an example about the routing of a transaction in a transaction transmission network according to a preferred embodiment of the present invention,

FIG. 5b shows an example about the assignment of fees in a transaction transmission network according to a preferred embodiment of the present invention, and

FIG. 6 depicts functional components of a computer usable as the computer of various embodiments of the present invention.

### DETAILED DESCRIPTION OF THE INVENTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing” or “calculating” or “determining” or “displaying” or “associating” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

Some embodiments of the present disclosure may include one or more application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. An API may also implement functions having parameters, variables, or pointers. An API may receive parameters as disclosed or other combinations of parameters. In addition to the APIs disclosed, other APIs individually or in combination can perform similar functionality as the disclosed APIs.

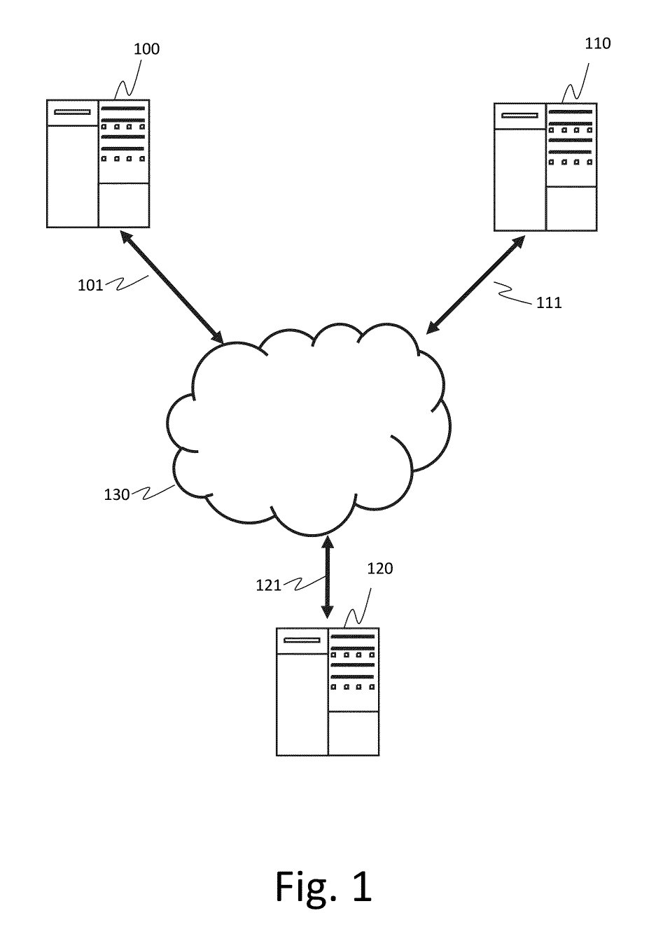

FIG. 1 depicts a computer and data communication arrangement according to a preferred embodiment of the present invention. The arrangement comprises a data communication network, e.g. a TCP/IP network, e.g. the Internet 130 to which a plurality of server computers may be communicatively connected. In the shown embodiment, the network may comprise at least one, preferably a plurality of server computers that act as transaction sources 100 connected to the network 130 using a communication connection 101. In an embodiment, the transaction source is an application service, e.g. an invoicing service that creates transactions, e.g. invoices, to be sent to the network 130. In another embodiment, the transaction source is a routing service that accepts the transaction from another system, e.g. an invoicing system of a business organization, and forwards it to the network 130.

The network further comprises at least one, preferably a plurality of server computers that act as transaction destinations 110 connected 111 to the network 130 using a communication connection 111. In an embodiment, the destination 110 is an application service, e.g. an invoice processing (approval) system of a buyer organization. In another embodiment, the transaction destination is a routing service that accepts the transaction from the network and forwards it to another system, e.g. the invoice processing system of a buyer organization. In yet another embodiment, the transaction destination is a value-add service provider that is arranged to receive transactions from the network for the purpose of providing a value-add service, e.g. a financing service for another entity in the network, e.g. the sender of the invoice.

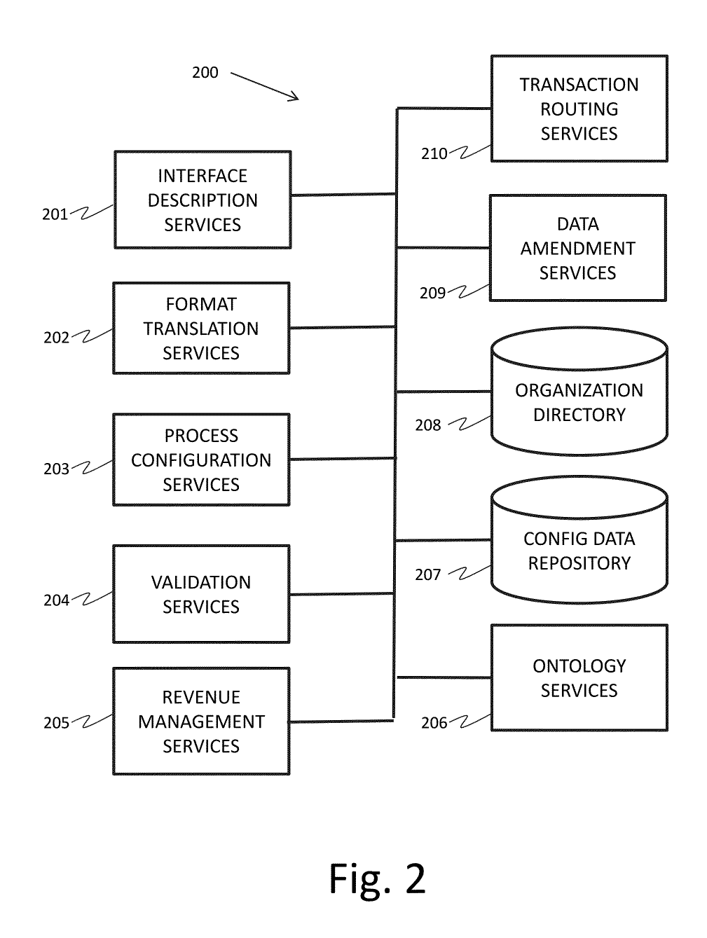

Finally, the network of the present embodiment comprises at least one server computer 120 communicatively connected 121 to the network 130. The server computer 120 provides services of a service network operator. An exemplary set of services of an embodiment of the present invention is illustrated e.g. in the FIG. 2 of this disclosure. In a preferred embodiment, the server computer 120 receives transactions from the sources of transactions 100 and forwards transactions to at least one destination of transactions 110. The server computer 120 further manages information about the configuration of the network, e.g. the requirements and capabilities of interfaces provided by the sources and destinations of the transactions. Yet further, the server computer monitors and analyses the transaction traffic in the network for the purpose of facilitating establishing business processes between transaction sources and destinations.

The server computers described herein may be e.g. physical servers or virtual servers known to a person skilled in the art.

FIG. 2 depicts an exemplary set of services 200 available at the server computer 120 of the arrangement of FIG. 1. The shown embodiment has for example interface description services 201 that are arranged to obtain information about capabilities and/or requirements of an interface of a service sending and/or receiving transactions and/or state change events to/from the network. The information may be stored e.g. in the configuration data repository 207. The interface description services may utilize the ontology services 206 for the description of the capabilities and/or requirements of the interface.

The set of services 200 may further comprise format translation services 202 that comprise means for a transaction source 100 to translate data from the internal format of the source into a standard format supported by the transaction transmission network 130. The translation services may utilize the ontology service 206 e.g. for mapping the data fields of the internal format into the data fields of the standard format. The translation services 202 may also comprise means for a transaction destination to translate data from the standard format supported by the transaction transmission network 130 into a format supported by the transaction destination 110.

In a preferred embodiment, the business process configuration services 203 specify the requirements for the data content and state change events for a business process between at least two end points comprising at least one source and at least one destination in the transaction transmission network 130. The process configuration data may also specify at least one value-add event, e.g. creation of a billing record, associated with the process. The process configuration data may for example specify, that a billing record is created for a participant of the process in the server 120 when a certain service using an interface is invoked at the transaction destination 110. In an embodiment, the process configuration data is derived from the capabilities of the source interface(s) and the requirements of the destination interface(s) of the process.

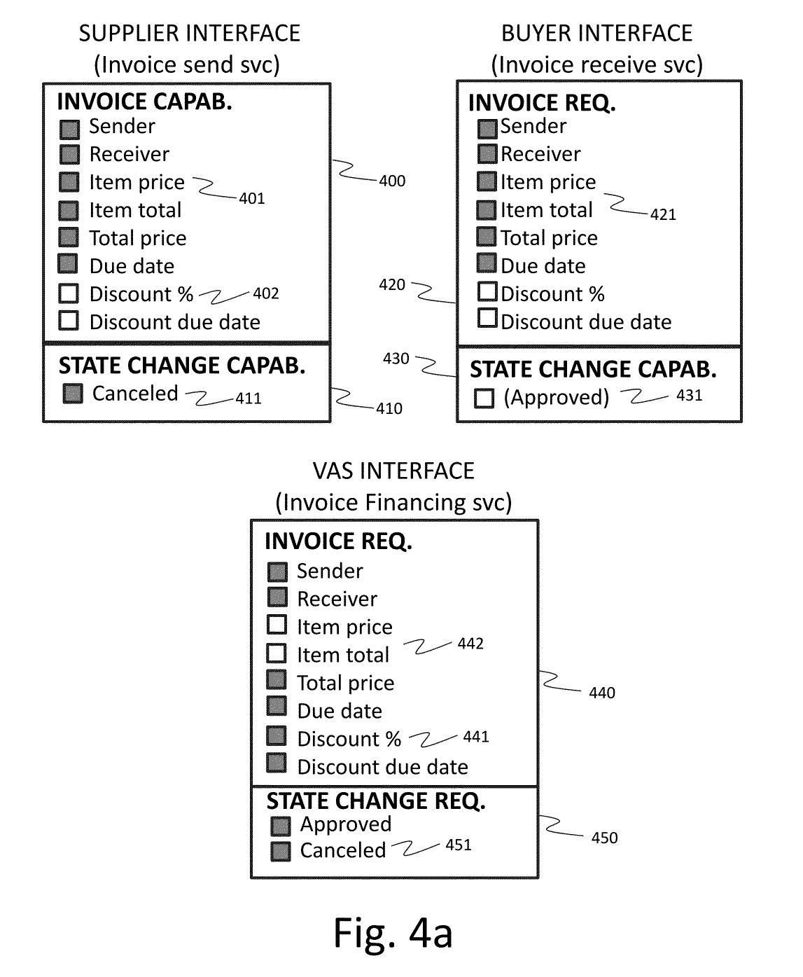

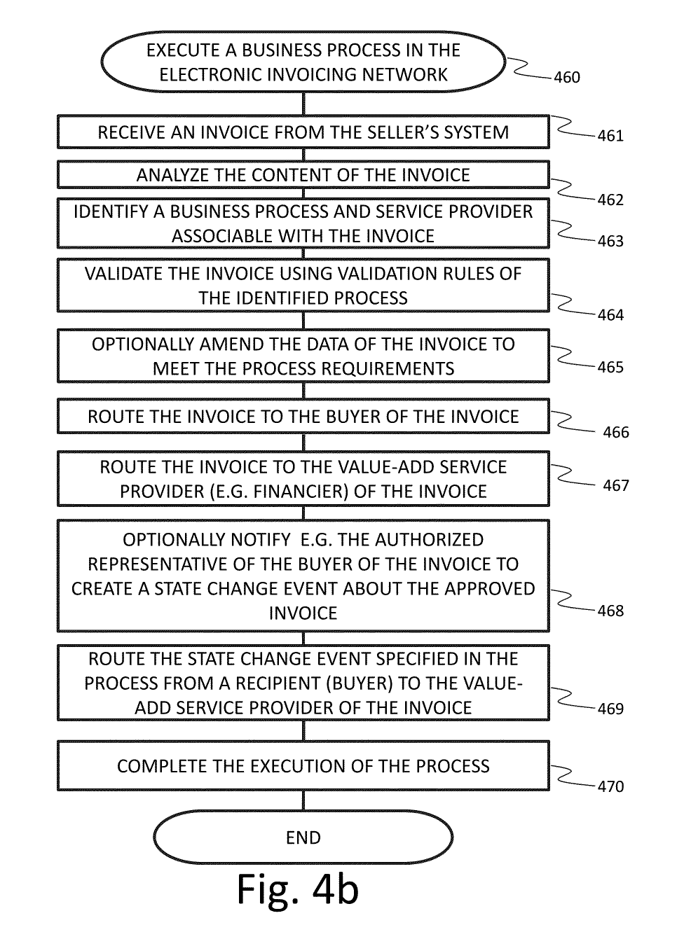

The business process configuration data may comprise for example the name and/or identifier of the process, e.g. “Financed invoicing”. The data may also specify the participants of the process. In an embodiment, the participants of the process comprise the sender and/or receiver of the transaction and at least one value-add service. The data may further comprise requirements for transaction data and state change events required by at least one interface participating in the process (see 440, 450 in FIG. 4a for an example). In an embodiment, the interface having requirements on the transaction data and state change events belongs to a value-add service of the process. The “financed invoicing” process may thus be associated with the interface of a “finance invoice” service implemented by a provider of an invoice financing service. The process configuration data may further comprise criteria that needs to be met in order to associate the process for a transaction. The criteria may for example require, that the transaction is an invoice and that the source (sender) of the transaction has subscribed to the value-add service (e.g. “finance an invoice”) of the process (e.g. “financed invoicing”). Yet further, the process configuration data may comprise information about revenue management of the process. For example, the provider of the value-add service (e.g. “finance an invoice”) may be charged a percentage of the service fee that the service provider charges from the sender of the invoice. A percentage of the charged percentage may be specified to be credited to the source (operator) of the transaction. If the process requires e.g. an “invoice approved” state change event from the recipient of the transaction, e.g. an invoice, the source (operator) of the state change event may be specified to be credited with another percentage of the charged percentage.

The validation services 204 of an embodiment of the present invention accept transactions, e.g. invoices or purchase orders, that arrive at the server 120 from a transaction source 100 and apply a set of validation rules defined e.g. by the business process configuration service 203 for a process between transaction source 100 and transaction destination 110 associable with the transaction. The validation services thus are adapted to identify a (business) process between two end points associable with the transaction and select a set of validation rules for the purpose of validating the transaction in the context of the identified process.

In a preferred embodiment, the revenue management services 205 are adapted to track the actions performed on the transaction of the process between at least two end points and record at least one value-add event regarding the transaction. The creation of the value-add event may be specified in the process configuration data created and maintained by the process configuration services 203. The value-add event may be e.g. a billing operation related to the transaction. The billing operation may be performed e.g. by the source or destination of the transaction or by a service provided at the server 120 of the arrangement. The revenue management services 205 may allocate the cost or revenue of the value-add event among the participants of the process e.g. according to some pre-determined allocation rules. In an embodiment, a percentage of the billed value-add event is allocated to the operator organization of the services running on server(s) 120. In another embodiment, a percentage of the billed value-add event is allocated to the other end point of the process. For example, if a value-add event occurs at the transaction destination, part of the revenue associated with the event may be credited to the source of the transaction and another part to the organization running a service on the server(s) 120. The revenue management services may be adapted to use the routing information of the data of the network in the process of determining the distribution of the revenue related to the data (e.g. a transaction and/or a state change event).

The ontology services 206 provide a common vocabulary and semantics for a plurality of other services 201-205 of the server 120. In a preferred embodiment, the ontology is based on a broad standard, e.g. UBL 2.1 (Universal Business Language). The ontology data may comprise e.g. a plurality of transaction type definitions, each type definition comprising a plurality of data field names each accompanied with description that provide the semantic meaning for the data fields.

Configuration data repository 207 is a data management service adapted to store the data of the services 201-206. The configuration data repository may thus comprise e.g. interface capability data, interface requirement data, format translation rules, process configuration data, process validation rules and revenue allocation rules.

Organization directory 208 comprises information about organizations, e.g. business organizations, that are associable with the transaction source and destination interfaces of the transaction transmission network 130 and information related to those interfaces. The information of the organization directory may thus be usable e.g. by the services 201-205 of the set of services 200. The business organizations may be e.g. suppliers or buyers of the network. They may also be providers of value-add services, e.g. financing, in the network. In an embodiment, the organization directory may also comprise information about processes defined or otherwise identified possible between organizations.

Data amendment services 209 comprise at least one service adapted to amend the data of a transaction received from the transaction source 100 to meet the requirements of a process between the transaction source 100 and target 110. The data amendment service may also comprise means for entering a state change event for a transaction transmitted earlier in the network 130.

In an embodiment, the data amendment services 209 comprise a user interface for manual entry of some missing data fields of a transaction and/or state change events for the transaction. For example, the transaction recipient (application service provider, financier) of an invoice financing process may require that the transaction data contains early payment discount percentage and related due date. The data amendment service 209 may provide a data key-in service for amending the data of the transaction with the missing discount percentage and due date fields. The access to the data amendment service may be granted to a user that represents the source of the transactions 100 using a suitable authentication and access authorization solution known to a person skilled in the art. The register of user accounts authorized to represent organizations may be implemented e.g. as part of the organization directory 208.

To continue the example further, the application service provider (financier) of the invoice financing process may require, that the buyer of the invoice sends to the network an “invoice approved” state change event when the invoice has been approved for payment in the buyer organization. If the invoice processing system (110) of the buyer is not able to send such state change event to the financier, the authorized representative of the buyer may enter the event for the transaction using the user interface of the data amendment services 209 available at the server 120 of the network 130.

The set of services 200 executable e.g. on the server 120 may further comprise a transaction routing service 210 that comprises means for analyzing the content and/or meta-data of an invoice received from a transaction source 100 and determine at least one recipient for the transaction, e.g. according to a business process definition. In an embodiment, the business process may involve multiple (e.g. more than two) parties and the transaction may have multiple recipients, e.g. the buyer of the invoice and the financing service provided by the financier of the invoice. The transaction routing service may also invoke other services of the network. It may for example resolve the processes applicable to the transaction from the process configuration services 203 and/or configuration data repository 207 and invoke the validation services 204 for the identified processes and the transaction. The routing service may further receive a state change event from a transaction source 100 or destination 110 and forward it to at least one recipient, which may be a transaction source 100 or destination 110 of a process e.g. according to the process information applicable to the transaction of the state change event.

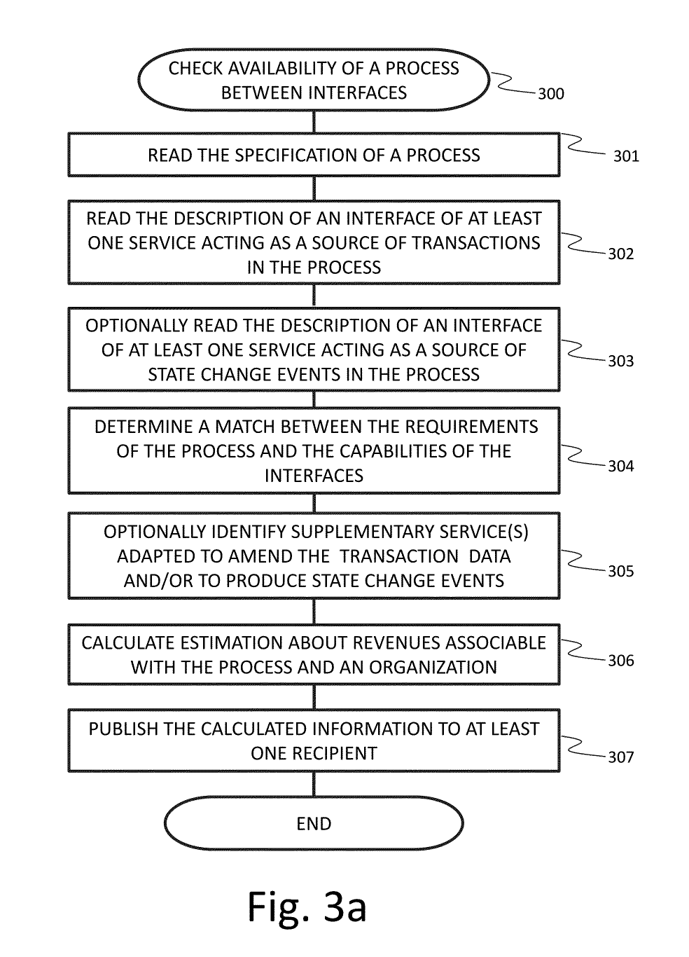

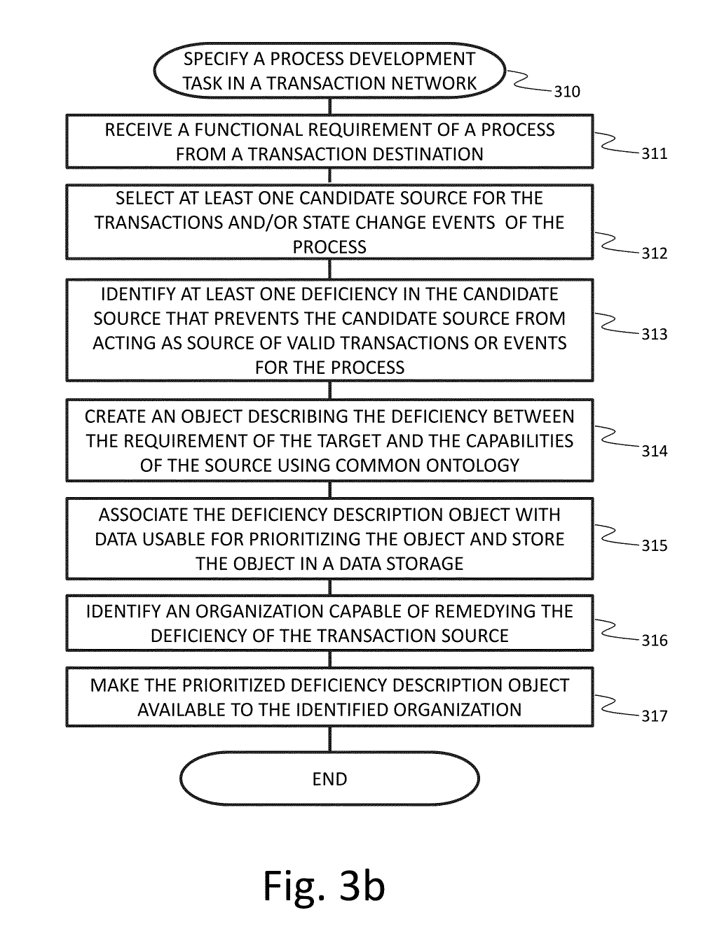

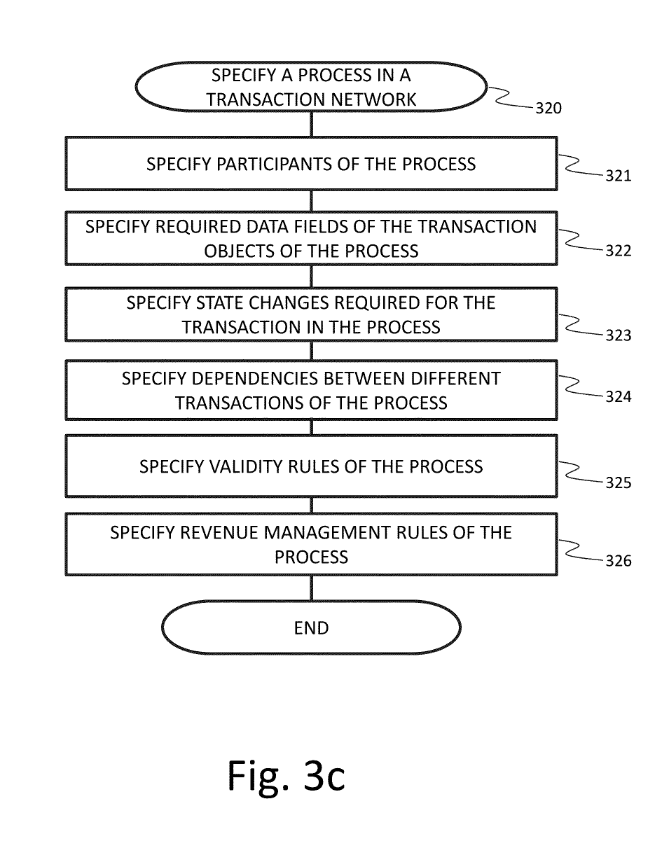

FIG. 3a depicts the method of checking the availability of a business process 300 between at least one transaction source and at least one transaction target in a transaction transmission network according to an embodiment of the present invention. The method may be implemented e.g. by the process configuration service 203. The method may be executed on as-needed basis, e.g. when a seller organization wants to subscribe to an invoice financing service or proactively, e.g. to identify seller-buyer-financier combinations between which a “financed invoicing” process may be activated. The specification of a process defined in the transaction network is read in step 301 into the memory of a computer. A more detailed exemplary method of creating a process specification is shown in FIG. 3c. The process specification may comprise e.g. a requirements description of an interface of a transaction target (destination). The transaction target may be e.g. a value-add service providing at least some of the functions required by the process in the network. An example of such interface is provided as a VAS (value-add service) interface 440, 450 in FIG. 4a. In an embodiment, the process may be e.g. “financed invoicing” and the service facilitating the process may be e.g. “finance an invoice” service provided by a financier organization (financing service provider). In step 302, the interface description of at least one service capable of acting as a source of transactions for the process is read. The interface may belong e.g. to a source of transactions, e.g. a sending operator service or an invoicing application service, that is anticipated to be a potential source of transactions for the process. Next in step 303, if the process requires at least one state change event from at least one participant of the process, the process configuration service reads the interface description of at least one service acting as a source of state change events in the process. In an embodiment, the state change event may be e.g. an indication from the recipient (buyer) of an invoice that the invoice has been approved for payment. In step 304, a match between process requirements and interface capabilities is determined for both the transaction content and state change events of the process. If the match is not a complete one, i.e. some content or state change event needed by the process is not available automatically from the data source interfaces of the process, the process configuration service 203 may identify supplementary services 305, e.g. (manual) data amendment services 209, from the set of services 200 to be invoked in the established process. In order for the data amendment service 209 to be available for the process, the service must have at least one user who is authorized to represent the source of the transaction or state change event. The method may thus comprise the step of checking the availability of at least one authorized user before associating the supplementary service with the process.

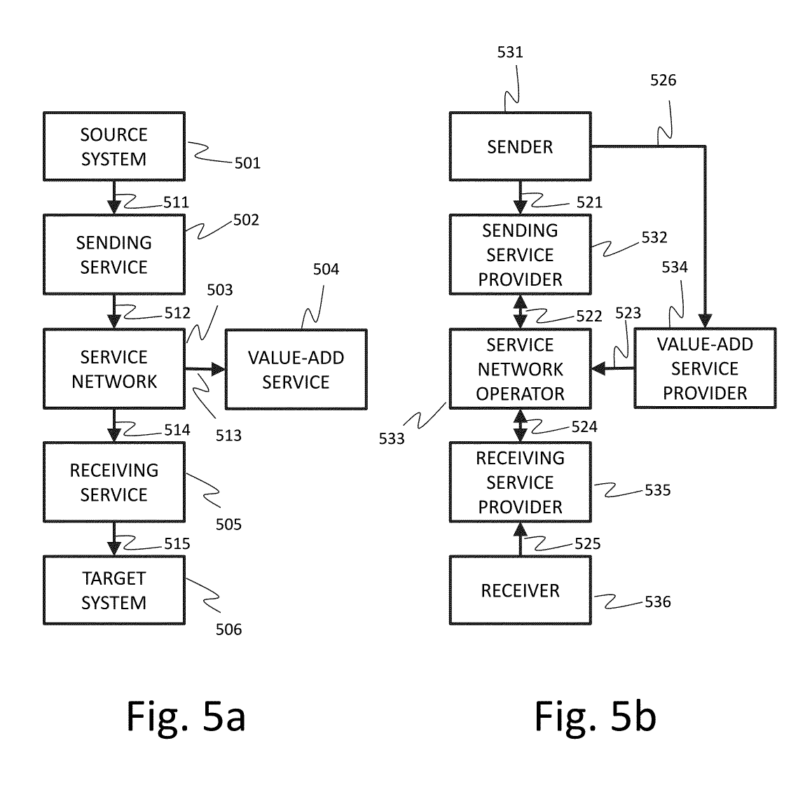

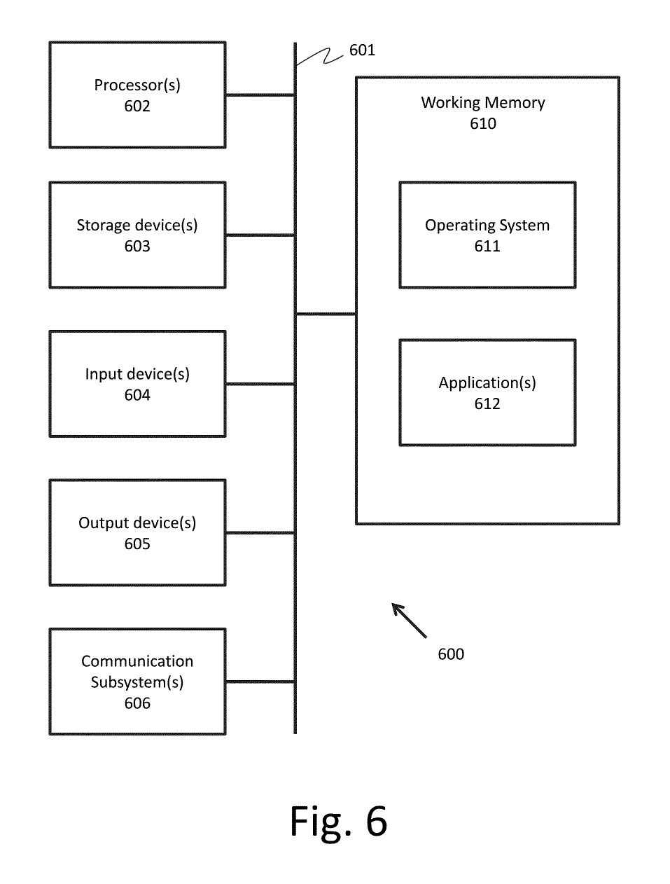

The method 300 may further comprise the step 306 of calculating financial information, e.g. estimation about revenues or earned revenues associable with the established process and an organization. In an embodiment, the revenues of a process may be shareable among the participants of the process according to a revenue sharing scheme e.g. as shown in FIG. 5b. For example, in a “financed invoicing” business process, a part of the revenue earned by the provider of the financing service may be shared with the source of the transaction 100, e.g. the routing service provided by the operator transmitting the financed transaction from the seller's system to the network 130. Another part of the revenue of the process may be shared with the source of a state change event required by the process. In a financed invoicing process of the present example, such source of state change events may be e.g. the operator transmitting transactions to the buyer's invoice approval system. The operator may transmit the information about approvals e.g. to the server 120 of the network 130 as a state change event.

To conclude the method of FIG. 3a, the calculated revenue information may be published 307 to at least one party (organization) associable with the specified process.

In an optimally working network, the use of manual data amendment services 209 should be minimized by automating the processes as extensively as possible. The efficient and prioritized development of the various interfaces and services of the transaction transmission network to be able to automatically deliver transaction data and events required by the processes requires organizing the development effort of the interfaces and services into prioritized tasks. The method 310 of FIG. 3b illustrates one computer-implemented embodiment of specifying such tasks. The method may be implemented utilizing the services of FIG. 2. The method begins with the step 311 of receiving a functional requirement, e.g. an interface description, from a transaction destination, e.g. from a service providing a value-add service, e.g. an invoice financing service. In step 312, at least one candidate source for the transactions and/or state change events of the process is selected. The candidate source may be e.g. an operator sending transactions to the network 130 from at least one invoicing system of at least one seller organization. Next, in step 313, at least one deficiency in the capabilities of the candidate source is identified. In an embodiment, the deficiency is of such nature that it prevents the candidate source from acting as the source of complete (usable) transactions for the process identified in step 311. The deficiency may be for example a missing data field of a transaction (e.g. early payment discount percentage of an invoice) or an unavailable state change (e.g. “invoice approved” event). In step 314, an object is created that describes the deficiency using a common ontology specified by the ontology service 206. The created deficiency description object is then associated 315 with data usable for prioritizing the object at the recipient of the object. The recipient of the object identified in step 316 may be e.g. the source of the transaction, e.g. a sending operator of invoices. In a preferred embodiment, the prioritization data comprises information about anticipated revenues achievable for the recipient of the object should the deficiency be fixed. Such data may be calculated e.g. by estimating the usage of the value-add service of the process and calculating revenue shareable with the recipient of the object based on the estimated usage of the service. One exemplary revenue sharing method is described in the FIGS. 5a and 5b of this disclosure. Based on this information, the recipient of the deficiency description object (e.g. transaction routing operator 100 sending transactions and/or state change events to the network) may prioritize the development efforts of its interfaces and related services to enable processes that are most profitable for the recipient. To complete the method of the present embodiment, the deficiency description object is published to the identified recipient 317.

FIG. 3c shows a flow diagram 320 about the method of specifying a business process in a transaction transmission network. The steps of this methods may be implemented e.g. as functions of the process configuration service 203. In step 321, the participant types (roles) of the process are specified. The participant types may comprise e.g. the sender of a transaction, the recipient of the transaction and/or at least one provider of a value-add service. In step 322, the data content of at least one transaction participating in the process is specified. An exemplary data content requirement of a business process is shown in FIG. 4a. Further, in step 323, state change event requirements for the transaction(s) of the process are specified. This step is optional, as not all processes require state change information from any participants of the process. If the process comprises a plurality of different transactions, the dependencies between the transactions may be specified in step 324. For example, a payment transaction may require, that the status of the related invoice is set to “approved” before the payment transaction may proceed. In step 325, the validity rules for the process are specified. The rules may be derived at least in part from the data content requirements, state change requirements and dependency specifications defined earlier in this method. Finally, in step 326, revenue management rules between the participants of the process are specified. In an embodiment, the rules specify at least one debiting event to charge a fee from one participant of the process, e.g. the provider of a value-add service. The rules may also specify at least one crediting event to credit a fee to at least one other participant of the process, e.g. the source of some data (transaction or state change event) required by the service of the process.

FIG. 4a depicts some exemplary interfaces of an embodiment of the present invention. Each interface comprises data requirement or capability specification (400, 420, 440) of at least one transaction transmitted to/from the interface. Each interface may further send or receive state change events (410, 430, 450) related to the transaction. In the shown embodiment, the interfaces are adapted to send/receive invoices and state change events, e.g. invoice approval events, related to them.

Transaction data interface 400 is the interface of the transaction source 100 (supplier system or routing operator connected to the supplier system) from which the transactions are sent to the invoice transmission network 130, e.g. to the services 200 of server 120. The enabled capabilities 401 of the interface comprise sending data related to the sender, the receiver, the item prices, the item totals, the total price and the due date of the invoice. The interface is unable 402 to provide the discount percentages and the discount due dates for early payment of the invoice. The supplier interface is also able to send one state change event 410 to the network if the invoice is canceled 411 by the supplier.

Transaction data interface 420 represents the interface of the transaction destination 110, e.g. a buyer system, e.g. invoice processing (approval) system, or a routing operator connected to the buyer system. The enabled capabilities 421 of the interface comprise receiving data related to the sender, the receiver, the item prices, the item totals, the total price and the due date of the invoice. The state change capabilities information 430 indicates that the interface is unable to send state change event messages related to invoice approval 431 to the servers 100, 110 and 120 of the network 130.

Transaction data interface 440 represents interface of the transaction destination 110 that belongs to a service provider providing a value-add service, e.g. an invoice financing service for a transaction, e.g. an invoice. The exemplary interface of the service requires 441 from the received invoice the sender, the receiver, the total price, the due date, the discount percentage and the discount due date information. Item-level information 442 (item unit price and total) are not required by the service provider. The value-add service requires further state change notifications 450 approval (from the buyer) and cancellation (from the seller) 451 of all invoices that the service provider is processing.

In an embodiment of the present invention, the requirements of a process, e.g. financed invoicing, between the supplier, buyer and the value-add service provider (e.g. financier) may be determined from the requirements information of the receiving interfaces 420, 440, 450. If the transaction source interface 400 is unable to meet the requirement of the destination interface (420, 440), the deficiency needs to be remedied before the transactions of the source may participate the process. Similarly, the state change event source interfaces (410, 430) must be able to provide the event change messages required by the event change receiving interface 450. Any deficiencies need to be remedied before data from the interface may be included in the process. In an embodiment of the present invention, the deficiencies may be remedied by including at least one data amendment service 209 into the process. Such service may e.g. allow user authorized to represent the transaction or state change event source to manually amend the data of the transaction or manually enter a state change event for the recipient who requires the data or event. The process may also be amended with a notification instruction that notifies the authorized user, e.g. using an electronic mail message, when a transaction needs to be manually amended or a state change event needs to be created using the data amendment service 209.

In another embodiment, a detected deficiency may be remedied by upgrading the interface. In this embodiment, the organization, e.g. a service provider of the transaction network, e.g. a routing operator of an invoice transmission network, having the capability to fix the deficiency is notified. In the embodiment shown in FIG. 4a, the supplier interface 400 needs to be upgraded to support sending of discount percentage and discount due date information of the invoices. Further, the buyer interface 430 should be updated to be capable of sending state change event messages 431 about approved invoices. To communicate the deficiency to the vendor of the source interface, for example the process configuration service 203 creates a deficiency description object (message) for the source and sends it to the vendor of the interface. The vendor of the supplier interface may thus receive a message that contains information about missing “discount percentage” and “discount due date” fields 402 that are required by the interface of the Invoice Financing service 440. The message may also contain information about anticipated revenues that would be available to the vendor of the supplier interface, should the interface allow sending of transactions to the value-add service. The estimation of the anticipated revenue streams and the management of the actual revenue streams between the transaction sources and destinations is provided by the revenue management service 205. In a preferred embodiment, there exists a revenue sharing scheme between the vendors of the interfaces that provides motivation for the vendors to develop compatible interfaces. In an embodiment, the provider of a value-add service (440, 450) receives revenue from the subscriber of the service and the revenue management service distributes part (e.g. a percentage) of this revenue to the sources of transactions 400 and state change events (410, 430) participating in the process enabled by the value-add service.

FIG. 4b shows a flow chart of a method of executing an exemplary business process comprising a value-add service, e.g. a financing process 460 in a transaction transmission network, e.g. the electronic invoicing network according to a preferred embodiment of the present invention. In step 461, the transaction routing service 210 receives a transaction, e.g. an invoice, from a transaction source 100. Next, the service analyzes the content of the transaction 462 and identifies at least one recipient for the transaction. The service also identifies a business process, e.g. a financing process 463 that is applicable to the received transaction, e.g. because the seller has subscribed to a financing service. The process may thus be applicable to the transaction for example if the sender or receiver of the transaction (e.g. seller or buyer of an invoice) has subscribed to a (value-add application) service that is implementing at least part of the process. Associated with the identified process is at least one validation rule. The invoice data is validated by the validation service 204. If the data of the invoice requires amendment, the transaction is sent 465 to the data amendment service 209 for manual amendment of the missing or invalid data. Additionally, a deficiency description object (see FIG. 3b) may be created and associated e.g. with a participant of the process, e.g. the operator of the related interface. The deficiency description object may be given an estimated a financial value, e.g. estimated revenue achievable if the deficiency of the interface is corrected so that the interface is able to send valid data automatically. Once the data is deemed valid, the invoice is routed 466 to the buyer's interface 420 in the server 110 of the network 130. Because the invoice falls into the scope of a defined process which comprises a subscribed service, the invoice is also routed 467 to the interface 440 of the invoice financing service of the financier of the invoice. The financing service may proceed with financing the invoice once it has received “invoice approved” state change event message from the buyer of the invoice. If the interface 430 of the buyer does not support automatic sending of such message, a service of the set of services 200, e.g. the routing service 210, may send a notification message, e.g. an e-mail message, to a user authorized to represent the buyer organization in the data amendment service 209 to create the state change message manually once the invoice has been approved at the buyer. Once the state change message has been received either from the interface 430 or from the data amendment service 209, the routing service 210 routes 469 the message to the interface 450 and the financing service may now proceed 470 with the financing of the invoice. In a preferred embodiment, one step of the execution of the business process is creation of at least one invoicing event to charge a fee from a participant of the business process. In a preferred embodiment, another step of the execution of the business process is creation of at least one invoicing event to credit a fee to another participant of the business process. This revenue sharing process is illustrated in more detail in FIGS. 5a and 5b.

FIG. 5a illustrates, by means of a schematic diagram, the route of a transaction in the network 130 of an embodiment of the present invention. The transaction is created at the system of the sender 501, e.g. an invoicing system, from which it is sent 511 to the routing system 502 (100 in FIG. 1) of an operator. In an embodiment, the sender's system is connectable directly, without the operator, to the network 130 and the sender system 501 thus is shown as 100 in the FIG. 1. The sender operator's system 502 forwards 512 the transaction to the service network 503. In a preferred embodiment, the operator 502 translates the message into a format supported by the service network. The operator 502 may utilize the format translation service 202 in the conversion process. Upon receiving the transaction, the routing service 210 of the service network resolves at least one recipient for the transaction. In the shown embodiment, there are two recipients. A copy of the transaction is sent 513 to the value-add service 504 that implements the interface 440 for receiving transaction data. The requirements of the interface are described using the service 201 and the resulting data is stored in the configuration data repository 207. Another copy of the transaction is sent 514 to the receiving service 505, which translates the transaction into the format supported by the receiver 506, e.g. an invoice processing (approval) system, and forwards 515 the transaction to the receiver. The translation may utilize e.g. the format conversion service 202 in the translation process.

In a preferred embodiment of the present invention, the value of the transaction transmitted in the network increases as some value-add services, e.g. financing, are provided on the transaction. FIG. 5b shows an example about how the added value and revenue generated from that value may be distributed among the participants (interfaces) of the process. In the shown example, the sender organization 531 has subscribed to a value-add service (VAS), e.g. a financing service, provided by a VAS provider 534. When the VAS provider has completed the service on the transaction, e.g. an invoice, it charges, e.g. using an invoicing event, a service fee 526 from the subscriber 531 of the service. In the shown embodiment, the value-add service provider 534 needs to share some of the earned revenue with the organizations 532, 533, 535 because those organizations contribute to the availability of the data that made the service of the VAS provider 524 possible. The VAS provider thus sends a share, e.g. a percentage, of the earned revenue 523 to the revenue management service 205 of the service network operator 533. The revenue management service may have an account for each participant 110, 120 of the network 130 for crediting and debiting service fees to/from the participant. Upon receipt of the payment to one of the accounts, the revenue management service resolves the participants of the process, e.g. 532, 535 who contributed to the data of the service and credits, e.g. using invoicing events, the accounts of those participants with a share, e.g. a percentage, of the payment it received from the VAS provider 534. In an embodiment, the routing information of the transactions and/or state change events is used to determine the recipients of the fees.

Value-add events, e.g. invoicing events where a fee is charged upon processing of at least one transaction may occur also elsewhere from the execution of a value-add service. In the shown embodiment, the sender of a transaction is charged 521 by the sending service provider 532 a fee for sending a transaction into the service network 503. Similarly, the receiver 536 of the transaction may be charged a fee 525 by the receiving service provider 535 about receiving the transaction from the network. In a preferred embodiment, the service network operator 533 charges a share, e.g. a percentage of those fees and credits at least one participant of the related process with a share of the charged fee. For example, the sender operator of a successfully delivered transaction may be credited with a percentage of the fee that the receiver operator charges from the recipient organization of the invoice document (transaction).

The fee (revenue) distribution mechanism disclosed herein may be used not only for determining profit sharing of provided services but also for estimating the value of establishing a new interface in the network. The value may be estimated e.g. using suitable service usage simulation techniques that are based e.g. on the already processed transactions of the network. The estimated value may be utilized e.g. in the step 315 of FIG. 3b. This mechanism thus provides an incentive for the transaction sources and targets to build compatible interfaces also for processes that they cannot directly charge any service fees. The anticipated revenues may also guide prioritization of the technical development work of the network to those tasks that maximize the overall revenues of the participants.

FIG. 6 shows a schematic illustration of one embodiment of a computer system that can perform the methods of the described embodiments of this disclosure. It should be noted that the FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 601 (or may otherwise be in communication, as appropriate). The hardware elements can include one or more processors 602, communication subsystems 603, one or more input devices 604, which can include without limitation a mouse, a keyboard and/or the like; and one or more output devices 605, which can include without limitation a display device, a printer and/or the like. The computer system 600 may further include (and/or be in communication with) one or more storage devices 603. The computer system 600 also can comprise software elements, shown as being located within the working memory 610, including an operating system 611 and/or other code, such as one or more application programs 612, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-method of an embodiment of the present invention.

Although specific embodiments have been described and illustrated, the embodiments are not to be limited to the specific forms or arrangements of parts so described and illustrated.

1.-5. (canceled)

6. A method for executing, by at least one computer, a business process comprising a plurality of participants and involving a plurality of data interfaces in a transaction transmission network, wherein the method comprises computer executable steps:
a. receiving a transaction or state change event from an interface acting as a source of transactions or state change events,
b. analysing the content of the transaction or state change event to identify at least one process that is applicable to the transaction or state change event,
c. validating the transaction or state change event using the validation rules of the identified process,
d. routing the transaction or state change event to at least one recipient interface according to the specification of the identified process,
e. receiving from at least one participant of the process an invoicing event indicating a fee charged from a first participant of the process, and
f. generating, according to the specification of the identified process, a second invoicing event indicating a fee to be credited to a second participant of the process.

7. A method according to claim 6, wherein the method comprises the step of amending the identified process according to the results of the validation of the transaction.

8. A method according to claim 7, wherein the step of amending the identified process comprises invocation of a service adapted to correct the deficiency in the data of the transaction identified in the validation of the transaction.

9. A method according to claim 7, wherein the step of amending the identified process comprises creating a deficiency description object adapted to comprise information for requesting upgrading the interface into one capable of automatically producing valid transactions or state change events for the process.

10. A computer arrangement for executing, by at least one computer, a business process comprising a plurality of participants and involving a plurality of data interfaces in a transaction transmission network, wherein the arrangement comprises means for:
a. analysing the content of the transaction or state change event to identify at least one process that is applicable to the transaction or state change event,
b. validating the transaction or state change event using the validation rules of the identified process,
c. routing the transaction or state change event to at least one recipient interface according to the specification of the identified process,
d. receiving from at least one participant of the process an invoicing event indicating a fee charged from a first participant of the process,
e. generating, according to the specification of the identified process, a second invoicing event indicating a fee to be credited to a second participant of the [symbol] .
